(19) United States
(12) Patent Application Publication
(10) Pub. No.: US 2026/0093523 A1
(43) Pub. Date: Apr. 2, 2026

(54) PROCESSING PARALLELISM FOR MACHINE LEARNING MODEL TRAINING

(71) Applicant: ADVANCED MICRO DEVICES, INC., Santa Clara, CA (US)

(72) Inventors: Sumanth Gudaparthi, Santa Clara, CA (US); Yao Cui Fehlis, New Braunfels, TX (US); Karthik Ramu Sangaiah, Bellevue, WA (US); Sonali Singh, Santa Clara, CA (US)

(21) Appl. No.: 18/901,890

(22) Filed: Sep. 30, 2024

(51) Int. Cl. G06F 9/48; G06N 20/00; G06T 1/20

(52) U.S. Cl. CPC G06F 9/4881; G06T 1/20; G06N 20/00

(57) ABSTRACT

A processing system schedules parallel training of different instances of a machine learning model (MLM) based on a number of microbatches associated with training the machine learning model. The number of microbatches, along with the time required to complete a forward and backward pass of the MLM per microbatch, indicates the position, in time, of one or more expected idle cycles of a processing unit during training of a first instance of the MLM. A scheduler of the processing system schedules a second instance of the MLM during the one or more expected idle cycles.

### BACKGROUND

Machine learning models are used in a wide variety of applications, including natural language processing, language translation, image processing and identification, and many others. Prior to being employed for a given application, a machine learning model (MLM) is trained by applying a set of training data to the MLM, and adjusting parameters of the MLM, such as one or more sets of weights for one or more layers of the MLM, until the MLM achieves a satisfactory performance. In many cases, training an MLM consumes a relatively high amount of resources, including processing resources and training time. To improve training efficiency, some training systems train multiple instances of the same neural network model where the weights of each model are different from another. This approach is suitable for example, in training model ensembles (where the weights of the models in the ensemble are initialized differently, usually by using different random seeds, or using different training data), hyperparameter tuning, finetuning a pretrained model on multiple sub-domains, language translation from various source to destination languages, and sentiment models for different languages (e.g., English Sentiment model, French Sentiment model and so on). However, conventional approaches to multi-instance training generate a relatively large number of idle processing cycles, limiting training efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that schedules parallel training of different instances of a machine learning model based on a number of micro-batches associated with the machine learning model in accordance with some embodiments.

FIG. 2 is an example of the processing system of FIG. 1 identifying an idle cycle timing threshold for training a machine learning model in accordance with some embodiments.

FIG. 3 is an example of the processing system of FIG. 1 scheduling parallel training of different instances of a machine learning model based on an idle cycle timing threshold in accordance with some embodiments.

FIG. 4 is a flow diagram illustrating a method of parallel training of different instances of a machine learning model based on a number of micro-batches associated with the machine learning model in accordance with some embodiments in accordance with some embodiments.

### DETAILED DESCRIPTION

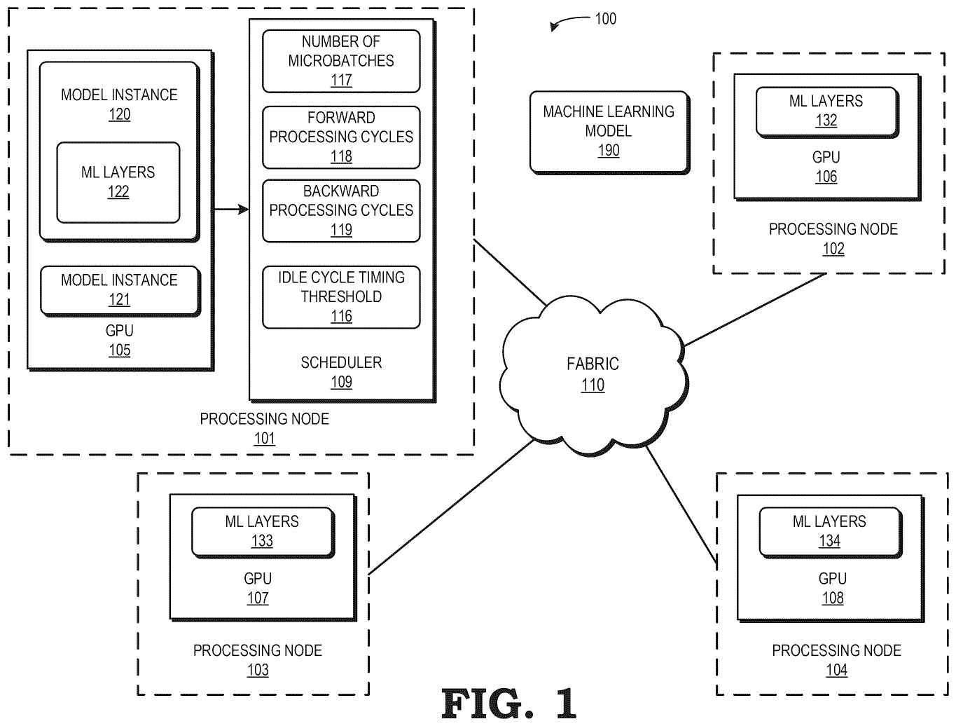

FIGS. 1-4 illustrate techniques for scheduling, at a processing system, parallel training of different instances of a machine learning model based on a number of microbatches associated with training the machine learning model. The number of microbatches, along with the time required to complete a forward and backward pass of the MLM per microbatch, indicates the position, in time, of one or more expected idle cycles of a processing unit during training of a first instance of the MLM. A scheduler of the processing system schedules a second instance of the MLM during the one or more expected idle cycles. The processing system thus reduces the number of idle cycles during training of the MLM instances, and thereby improves overall MLM training efficiency.

To illustrate, conventional MLM training systems employ multiple processing units (e.g., multiple graphics processing units (GPUs) to train an MLM. To increase the output throughput, an MLM training system employs distribution strategies such as data parallelism, and model parallelism. Pipeline parallelism is a prominent form of model parallelism technique that shares the layers of a machine learning model across multiple devices, thereby supporting (i) scalability, and (ii) addressing the insufficient memory capacity to encapsulate large models within a single processing unit. However, this parallelization strategy results in idle cycles wherein one or more of the processing units are waiting for one or more other processing units to complete a computation. For example, in a given training system, an MLM is distributed across four processing units. If the MLM has eight layers, then in this example each processing unit executes two different layers of the MLM during training. For training, the operations of the MLM are divided into a set of minibatches, wherein each minibatch is a different subset of the training samples. Each minibatch is split into multiple microbatches to allow for overlapping of individual microbatch execution. Thus, for example, if the MLM has a batch size of 8, the MLM is divided into eight microbatches each of size one. Layers one and two are executed at a first processing unit and layers three and four of the MLM are executed at a second processing unit. Thus, for proper training, a given microbatch must complete the first and second layers at the first processing unit before the second processing unit executes the third and fourth layers. This results in one or more idle cycles at one or more of the processing units.

To reduce the number of idle cycles, using the techniques described herein, a scheduler identifies a point in time referred to herein as the idle cycle timing threshold, which is a point in time in an MLM training schedule, for a first MLM instance, wherein the number of expected idle cycles following the threshold matches the number of active cycles prior to the threshold. In some embodiments, the scheduler determines the idle cycle timing threshold based on a combination of the total number of microbatches per minibatch used for training an instance of the MLM training, the number of cycles used to execute a forward pass for each microbatch at the processing unit, and the number of cycles used to execute a backward pass for each microbatch at the processing unit. The scheduler then identifies the position (in time) of the expected idle cycles based on the idle cycle timing threshold and schedules a second MLM instance for training during the expected idle cycles. Because the second MLM instance has the same design as the first MLM instance, the training cycles for the second MLM instance fit into the expected idle cycles for the first MLM instance. The scheduler thus improves overall training efficiency for the two MLM instances without impacting training performance.

FIG. 1 illustrates a processing system 100 that is generally configured to train a machine learning model neural network (referred to herein as a machine learning model, or MLM, 190 for simplicity) in accordance with some embodiments. In some embodiments, the MLM 190 is a transformer model such as a large language model (LLM). Accordingly, in various embodiments, the processing system 100 is part of any one of a number of electronic devices that employ an MLM, such as a server (or set of servers), a desktop computer, a laptop computer, a game console, a smartphone, and the like.

In at least some embodiments, the MLM 190 includes a plurality of layers that each perform specified operations based on a received input data (e.g., a token representing words, characters, or phrases, an input vector, or an input matrix) to generate output data, such as an output vector or output matrix. Examples of the layers in some embodiments include self-attention layers, normalization layers, gating functions, and experts. To illustrate, in some cases, when the MLM 190 (or an instance of the MLM 190) is executed, a self-attention layer of the MLM 190 receives an input token, either from another layer of the MLM 190 or as initial input token for the MLM 190. The self-attention layer performs one or more self-attention operations based on the input token and provides the result to a normalization layer, which normalizes the resulting token to generate an output token. The output token is provided to another layer of the MLM 190, or as an output of the model. Furthermore, in some embodiments the MLM 190 includes a plurality of one or more self-attention layers, normalization layers, gating functions, and experts chained together to collectively implement the model.

The processing system 100 is generally configured to train instances of the MLM 190. As used herein, an instance of the MLM 190 refers to an MLM that has the same structure or architecture as the MLM 190 but has different weights than other instances of the MLM 190. In the example of FIG. 1, the processing system 100 is configured to train two instances of the MLM 190, designated model instance 120 and model instance 121. Thus, the model instances 120 and 121 have the same structure or architecture as the MLM 190 (and thus the same number of layers and interconnection between the nodes and layers of the MLM) but have different weights for one or more of the layers. In some embodiments, at least one of the model instances 120 and 121 is a byproduct of data-parallelism, and the processing system 100 is configured to train several data parallel instances. The several data-parallel instances (e.g., on the order of thousands of data parallel instances) are organized in pairs of two with each pair having the same copy of the MLM weights, thereby reducing the memory footprint.

The processing system 100 is generally configured to train the model instances 120 and 121. To train a model instance, the processing system 100 applies a sets of training data to inputs of the model instance, propagates the inputs through the layers of the model instance, determines a set of errors for one or more of the layers based on an output of the layer or model instance and an expected output, and adjusts the weights of one or more layers of the model instance based on the set of errors. In some embodiments, the set of training data for the model instance 120 is different than the set of training data for the model instance 121.

In at least some embodiments, the processing system 100 trains a model instance by executing training passes for the model instance. During a training pass, test data is applied to one or more layers of the model instance, and the resulting output data is employed to train the model instance, such as by adjusting one or more weights for one or more layers of the model instance. In some embodiments, each training pass includes both a forward pass (also known as forward propagation) at each layer of the and a backward pass (also known as backward propagation). During the forward pass of a layer, inputs are provided to the layer (e.g., from another layer of the model instance), and the layer generates corresponding outputs based on the activation function and weights of the layer. The processing system 100 calculates the error for the layer, and then, for the backward pass, uses the calculated error to adjust the weights of the layer, such as by adjusting the weights based on gradient descent.

To execute the operations for training the model instances 120 and 121, the processing system 100 includes a plurality of processing nodes, designated processing nodes 101-104. It will be appreciated that, in different embodiments, the processing system 100 includes fewer or more processing nodes than are illustrated at FIG. 1. The processing nodes 101-104 are all connected to a communication fabric 110 that is generally configured to communicate data (e.g., messages, packets, or other units of information) between the processing nodes. Accordingly, in different embodiments the communication fabric is an internal processor fabric, such as a Peripheral Component Interconnect Express (PCIe) fabric, a network fabric (e.g., one or more of a local area network and a wide area network (e.g., the Internet), a server interconnect, and the like, or any combination thereof.

Each of the processing nodes includes a set of processing circuitry, as well as supporting circuitry, to execute at least a portion of one or more layers of the MLM 190. In particular, each of the processing nodes 101 includes at least one processing unit, designated processing units 105-108 respectively. The processing units 105-108 are generally configured to execute operations to implement one or more layers (e.g., self-attention layers, normalization layers, gating functions, and experts) of the MLM 190. The processing units 105-108 thus include sets of processing elements (e.g., compute units, single-instruction multiple-data (SIMD) units, processor cores, command processors, and the like, or any combination thereof), along with supporting circuitry (caches, schedulers, command buffers, and the like) that collectively execute the sets of operations corresponding to the transformer model layers. For purposes of description, it is assumed that the processing units 105-108 are graphics processing units (GPUs). However, in other embodiments the processing units are any type of parallel processor, such as vector processors, general-purpose GPUs (GPGPUs), non-scalar processors, highly-parallel processors, artificial intelligence (AI) processors, inference engines, machine learning processors, other multithreaded processing units, and the like.

In at least some embodiments, the processing nodes 101-104 include additional circuitry not illustrated at FIG. 1. For example, in some embodiments one or more of the processing nodes 101-104 includes a central processing unit (CPU) generally configured to control the operations at one or more of the processing units 105-108 via, for example, the generation of one or more commands that instigate operations at the corresponding processing units. In addition, in some embodiments each of the processing nodes 101-104 includes one or more memory devices (e.g., dynamic random-access memory (DRAM) devices) that are configured to store data on behalf of the processing units, such as weights for one or more layers of the MLM 190.

Each of the processing nodes 101-104 also includes a scheduler generally configured to schedule operations, such as MLM training operations, at the corresponding processing unit. For example, the processing node 101 includes a scheduler 109 (the schedulers are not illustrated for processing nodes 102-104 for clarity). To increase training efficiency, the schedulers are generally configured to divide the training operations for the model instances 120 and 121 across the processing nodes 101-104, so that the processing nodes 101-104 execute at least some of the training operations in parallel. Thus, the schedulers are generally configured to collectively identify the layers of model instances 120 and 121 to be executed at each processing node, such that layers 122 are executed at processing node 101, layers 132 are executed at processing node 102, layers 133 are executed at processing node 103, and layers 134 are executed at processing node 104. The schedulers are further configured to divide the training operations for each layer into a set of minibatches, and to divide each minibatch into a corresponding set of microbatches. The schedulers then schedule execution of each microbatch at corresponding ones of the processing nodes 101-104, so that the microbatches of each layer are executed at the corresponding processing nodes. It will be appreciated that the embodiment of FIG. 1, wherein each processing node includes a scheduler, is an example embodiment only, and in other embodiments different configurations of scheduling hardware are employed. For example, in some embodiments the processing system 100 includes a single scheduler circuit for all of the processing nodes 101-104 (e.g., a single scheduler circuit that schedules training at each of the processing nodes 101-104.

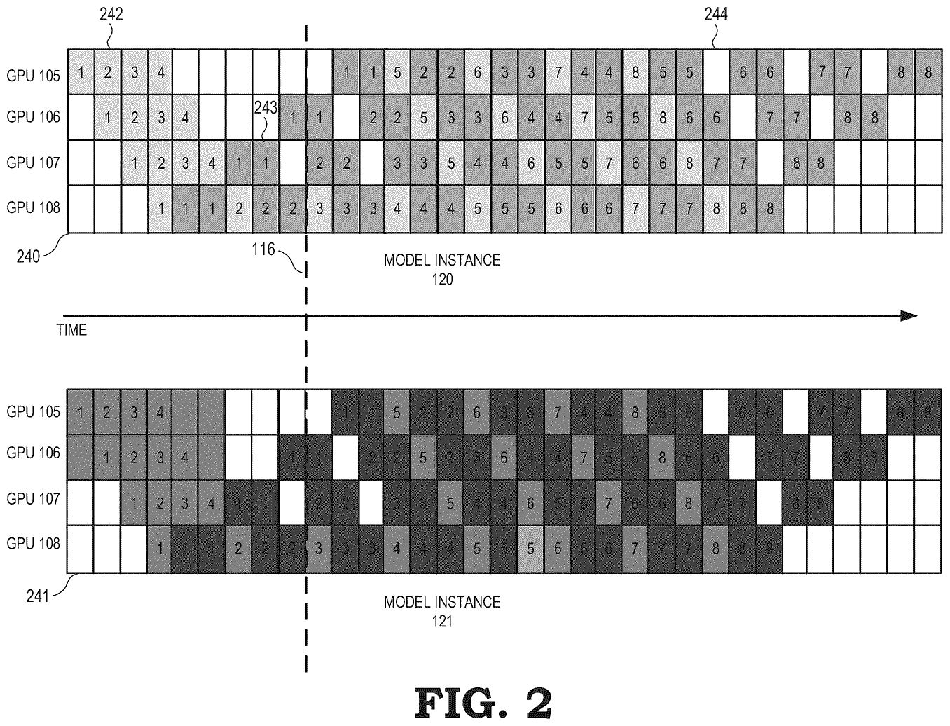

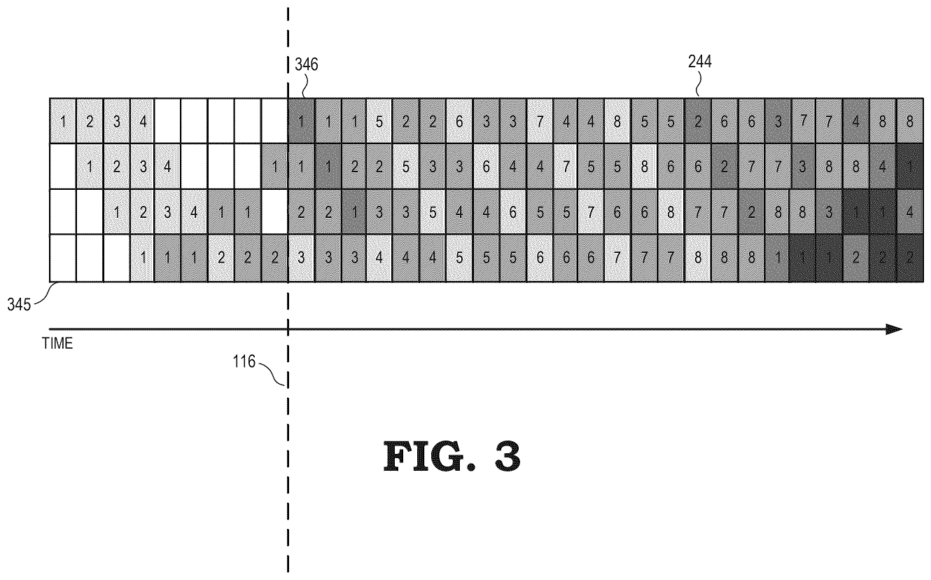

For example, in some embodiments the MLM 190 (and thus each of the model instances 120 and 121) includes eight layers and has a batch size of eight. The schedulers of the processing nodes 101-104 distribute the eight layers so that each of the GPUs 105-108 is assigned two different layers of a model instance. In addition, the schedulers divide each batch of the model instance into minibatches, and further divide the minibatches into microbatches. The schedulers then assign each microbatch to a corresponding one of the GPUs 105-108 for execution. This allows the microbatches to be scheduled so that at least some of the microbatches are executed in parallel, as described further below with respect to FIGS. 2 and 3.

Under conventional training techniques, the model instances 120 and 121 are trained independently, and one instance at a time. Thus, for example, layers of the model instance 120 are trained at the GPUs 105-108, and then subsequently the layers of the model instance 121 are trained. However, under these conventional approaches, the GPUs 105-108 experience idle cycles (e.g., as a GPU awaits generation of an output by another GPU), wherein at least one of the GPUs 105-108 is not performing useful work. These idle cycles have a negative impact on training efficiency.

To reduce the number of idle cycles, and thereby improve training efficiency, the scheduler 109 is configured to determine an idle cycle timing threshold 116, that indicates a point in time of a training schedule for a model instance wherein the number of idle cycles after the threshold 116 matches a number of active cycles prior to the threshold 116. The idle cycle timing threshold 116 therefore indicates when there are a sufficient number of expected idle cycles in a training schedule to schedule training of another model instance. Accordingly, the scheduler 109 uses the idle cycle timing threshold 116 to identify idle cycles associated with training a model instance (e.g., model instance 120) and schedules training of another model instance (e.g., model instance 121) during the identified idle cycles. The GPUs 105-108 then concurrently train the model instances 120 and 121 according to the schedule. The model instances 120 and 121 are thus trained with a fewer number of overall processing cycles, thus improving training efficiency.

In some embodiments, to identify the idle cycle timing threshold 116, the scheduler 109 employs a number of characteristics of the MLM 190 and its corresponding training schedule. For example, in some embodiments, the scheduler 109 determines the idle cycle timing threshold 116 based on a number of microbatches 117, a number of forward processing cycles 118, and a number of backward processing cycles 119. The number of microbatches 117 is the total number of microbatches used to train a model instance, the number of forward processing cycles 118 is the number of processing cycles to complete a forward pass per microbatch per GPU, and the number of backward processing cycles is the number of processing cycles to complete a backward pass per microbatch per GPU. As used herein, processing cycles are a unit of time corresponding to one or more clock cycles of a processing unit. In some embodiments, the processing cycles are expressed in a relative or normalized fashion, such that a processing cycle corresponding to multiple clock cycles of a processing unit but indicates a relative amount of time to complete a corresponding operation. Thus, for example, in some cases a backward pass requires twice as many clock cycles as a forward pass, and therefore the number of forward processing cycles 118 is expressed as a value of one and the number of backward processing cycles 119 is expressed as a value of two.

In some embodiment, the scheduler 109 determines the idle cycle timing threshold 116 using the following formula:

$$\# microbatches * ( Tf + Tb )$$

where #microbatches is the number of microbatches 117, Tf is the number of forward processing cycles 118, and Tb is the number of backward processing cycles 119.

An example of the scheduler 109 scheduling concurrent training of the model instances 120 and 121 is illustrated at FIGS. 2 and 3 in accordance with some embodiments. FIG. 2 depicts two training schedules, designated schedule 240 and 241. The schedule 240 corresponds to a specified initial training schedule for the model instance 120 and the schedule 241 corresponds to a specified initial training schedule for the model instance 121.

In the illustrated example, each of the schedules 240 and 241 has four rows and thirty-three columns, wherein each row corresponds to a different one of the GPUs 105-108, and each of the columns corresponds to the number of total processing cycles of the corresponding GPU that are used to execute a microbatch at the GPU. For simplicity, it is assumed for the example of FIGS. 2 and 3 that each column corresponding to one processing cycle, but it will be appreciated that in other embodiments each column represents multiple processing cycles. A numbered entry in a schedule indicates the microbatch being processed at the corresponding GPU during the corresponding processing cycle. A blank entry indicates that the corresponding GPU is idle during the corresponding processing cycle. Furthermore, a lighter shading of an entry indicates a forward pass for the corresponding model instance, and a darker shading of an entry indicates a backward pass for the corresponding model instance. In addition, the entries of the schedules 240 and 241 are shaded differently to indicate entries for the different model instances 120 and 121, with schedule 241 having relatively darker shading.

Thus, in the example of FIG. 2, the entry 242 indicates that a forward pass for microbatch 2 is scheduled to be executed at GPU 105 during the corresponding processing cycle. The entry 243 indicates that a part of a backward pass for microbatch 1 is scheduled to be executed at GPU 107 during the corresponding processing cycle. The entry 244 indicates that an idle cycle is scheduled for GPU 105 during the corresponding processing cycle.

In the illustrated example, at least some training operations are concurrently scheduled for a given model instance. Thus, for example, the schedule 240 initiates execution of a forward pass microbatch 1 at the GPU 105. Upon completion of execution of microbatch 1 (that is, upon executing a forward pass at the layers of model instance 120 assigned to GPU 105), the GPU 105 provides the resulting outputs to GPU 106. During the next processing cycle, the GPU 106 uses the data provided by GPU 105 to execute a forward pass of the layers 122 of the model instance 120 assigned to the GPU 106 and provides the resulting output data to the GPU 107. In addition, during the same processing cycle, the GPU 105 initiates execution of microbatch 2. Thus, under the schedule 240, once the input data is available for a GPU to execute a corresponding microbatch (because, for example, another GPU has completed generating the input data), the GPU executes the microbatch. Because the layers are distributed among the GPUs 105-108, different GPUs execute different microbatches, at the corresponding layers, in parallel. However, as shown in the example of FIG. 2, there are some processing cycles wherein the input data for a particular backward or forward pass is not available (has not yet been generated), and the corresponding GPU is therefore idle for one or more processing cycles as it awaits generation of the input data. For example, entry 244 shows that an idle cycle occurs at the GPU 105 because the input data to execute a backward pass of microbatch 6 has not yet been generated by the GPU 106.

To reduce the number of idle cycles at the GPUs 105-108, the scheduler 109 takes advantage of at least two features of the schedules 240 and 241. First, because the model instances 120 and 121 have the same structure or architecture, the schedules 240 and 241 have the same timing structure. Furthermore, the schedules 240 and 241 are such that at a particular point in time, designated the idle cycle timing threshold 116 (illustrated as a vertical dashed line in FIG. 2), the number of idle cycles after the threshold 116 (to the right of the line) matches the number of active (that is, non-idle cycles) prior to the threshold 116 (to the left of the line). This feature of the schedules 240 and 241 allows the scheduler 109 to combine the schedules 240 and 241, so that the active cycles of the schedule 241 are scheduled during the idle cycles of the schedule 240, resulting in the schedule 345 of FIG. 3.

In particular, FIG. 3 depicts a schedule 345 generated by the scheduler 109 by merging the schedule 241 with the schedule 240 in accordance with some embodiments. To generate the schedule 345, the scheduler 109 identifies idle cycles in the schedule 240 based on the idle cycle timing threshold 116, and replaces the identified idle cycles with microbatches of the schedule 241. Thus, for example, in schedule 345 the entry 244 of schedule 240 is identified by the scheduler 109 as an idle cycle and is replaced with a forward pass of microbatch 2 for the model instance 120 at GPU 105. Similarly, as shown by entry 346, in the schedule 345 an idle cycle of schedule 240 is replaced by a forward pass of batch 1 for the model instance 121. Thus, the scheduler 109 generates the schedule 345 by interleaving training operations of one model instance (in this case, model instance 121) between training operations of another model instance (model instance 120).

After generating the schedule 345, the scheduler 109 provides commands to the GPUs 105-108 to execute the microbatches of the model instances 120 and 121 according to the schedule. In response, the GPUs 105-108 execute the microbatches in the sequence indicated by the schedule 345. Thus, the processing system 100 executes training operations for the model instances 120 and 121 concurrently (that is, in parallel), and with relatively few idle cycles, thus improving overall training efficiency of the model instances.

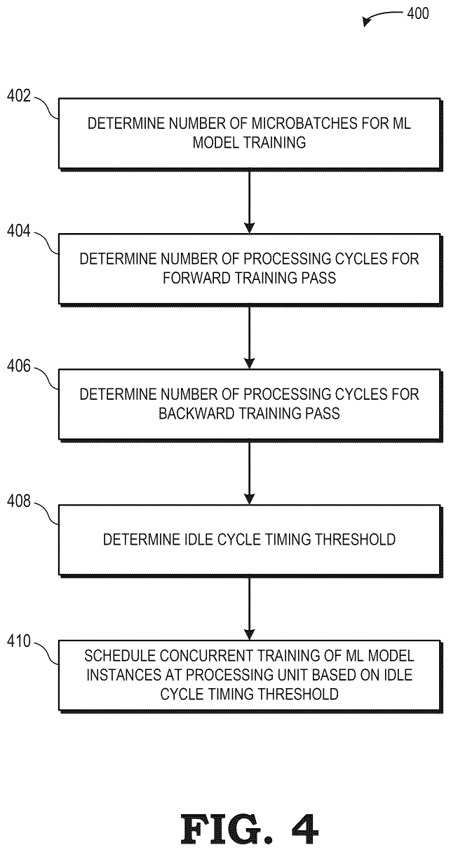

FIG. 4 illustrates a flow diagram of a method 400 of training model instances in parallel at a processing system in accordance with some embodiments. For purposes of description, the method 400 is described with respect to an example implementation at the processing system 100 of FIG. 1, but it will be appreciated that in other embodiments the method 400 is implemented at processing systems having different configurations. At block 402, the scheduler 109 identifies an initial training schedule for model instances of the MLM 190. For example, in some embodiments the scheduler 109 employs a PipeDream training schedule as the initial schedule. In other embodiments the initial scheduler is a one-forward-pass one-backward-pass (1F1B) schedule. The scheduler 109 then determines, based on the structure or architecture of MLM 190 and the initial schedule, the number of microbatches that will be employed to train each instance of the MLM 190.

At block 404 the scheduler 109 identifies, based on the initial schedule, the number of processing cycles that are to be used for each forward pass of a microbatch for training instances of the MLM 190. At block 406 the scheduler identifies, again based on the initial schedule, the number of processing cycles that are to be used for each backward pass of a microbatch for training instances of the MLM 190. In some embodiments, the number of processing cycles for the forward pass and the number of processing cycles for each backward pass are each expressed as an amount relative to the other. For example, if each backward pass requires twice the number of processing unit clock cycles to execute than is required to execute a forward pass, the number of processing cycles for a backward pass is expressed as the number 2, and the number of processing cycles for a forward pass is expressed as the number 1.

At block 408, the scheduler 109 determines the idle cycle timing threshold 116 based on a combination of the number of microbatches, the number of processing cycles for each forward pass, and the number of processing cycles for each backward pass. As described above, the idle cycle timing threshold 116 indicates the point, in the initial schedule, where the number of expected idle cycles following the threshold is equal to the number of active (non-idle) cycles prior to the threshold.

At block 410, the scheduler 109 generates, based on the initial schedule and the idle cycle timing threshold 116, a revised schedule that combines the scheduling of microbatches for one model instance (e.g., model instance 120) with the scheduling of microbatches for at least one other model instance (e.g., model instance 121). In at least some embodiments, the scheduler 109 combines the scheduling of the model instances by identifying (based on the initial schedule) an expected idle cycle for one model instance and replacing the idle cycle with a microbatch for a different model instance. After generating the revised schedule, the scheduler 109 sends commands to the GPUs 105-108 to execute microbatches of the different model instances according to the revised schedule. In response, the GPUs 105-108 execute the microbatches according to the revised schedule, thereby concurrently training at least two different instances of the MLM 190.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
determining a number of microbatches associated with a training pass of a machine learning model; and
scheduling concurrent training of a first instance of the machine learning model and a second instance of the machine learning model at a plurality of processing units based on the determined number of microbatches.

2. The method of claim 1, wherein the training pass includes a plurality of forward passes of the machine learning model, and further comprising:
determining a first number of processing cycles for executing the plurality of forward passes; and
scheduling the concurrent training further based on the determined first number of processing cycles.

3. The method of claim 2, wherein the training pass includes a plurality of backward passes of the machine learning model, and further comprising:
determining a second number of processing cycles for executing the plurality of backward passes; and
scheduling the concurrent training further based on the determined second number of processing cycles.

4. The method of claim 1, wherein the determined number of microbatches indicates timing of a plurality of idle cycles associated with training of the first instance of the machine learning model.

5. The method of claim 4, wherein scheduling comprises scheduling training of the second instance of the machine learning model during the plurality of idle cycles associated with training of the first instance of the machine learning model.

6. The method of claim 1, wherein scheduling comprises interleaving at least one training cycle of the second instance of the machine learning model between instances of the first instance of the machine learning model.

7. The method of claim 1, wherein a first processing unit of the plurality of processing units executes a first layer of the first instance of the machine learning model, and a second processing unit of the plurality of processing units executes a second layer of the first instance of the machine learning model.

8. The method of claim 7, wherein the first processing unit executes a first layer of the second instance of the machine learning model corresponding to the first layer of the first instance of the machine learning model.

9. A method, comprising:
determining, based on a number of microbatches associated with training a machine learning model, a number of idle cycles at first processing unit; and
scheduling training of a first instance of the machine learning model and a second instance of the machine learning model based on the determined number of microbatches.

10. The method of claim 9, further comprising:
determining a first number of processing cycles for executing a forward pass of the machine learning model; and
wherein scheduling training comprises scheduling training based on the first number of processing cycles.

11. The method of claim 10, further comprising:
determining a second number of processing cycles for executing a backward pass of the machine learning model; and
wherein scheduling training comprises scheduling training based on the second number of processing cycles.

12. The method of claim 9, wherein scheduling comprises scheduling training of the second instance of the machine learning model during idle cycles associated with training the first instance of the machine learning model.

13. A processing system, comprising:
a plurality of processing units; and
a scheduler configured to:
determine a number of microbatches associated with a training pass of a machine learning model; and
schedule concurrent training of a first instance of the machine learning model and a second instance of the machine learning model at the plurality of processing units based on the determined number of microbatches.

14. The processing system of claim 13, wherein the training pass includes a plurality of forward passes of the machine learning model, and wherein the scheduler is configured to:
determine a first number of processing cycles for executing the plurality of forward passes; and
schedule the concurrent training further based on the determined first number of processing cycles.

15. The processing system of claim 14, wherein the training pass includes a plurality of backward passes of the machine learning model, and wherein the scheduler is configured to:
determining a second number of processing cycles for executing the plurality of backward passes; and
scheduling the concurrent training further based on the determined second number of processing cycles.

16. The processing system of claim 13, wherein the determined number of microbatches indicates timing of a plurality of idle cycles associated with training of the first instance of the machine learning model.

17. The processing system of claim 16, wherein the scheduler is configured to schedule training of the second instance of the machine learning model during the plurality of idle cycles associated with training of the first instance of the machine learning model.

18. The processing system of claim 13, wherein scheduling comprises interleaving at least one training cycle of the second instance of the machine learning model between instances of the first instance of the machine learning model.

19. The processing system of claim 13, wherein a first processing unit of the plurality of processing units executes a first layer of the first instance of the machine learning model, and a second processing unit of the plurality of processing units executes a second layer of the first instance of the machine learning model.

20. The processing system of claim 19, wherein the plurality of processing units comprise graphics processing units (GPUs).
